(19) United States
(12) Patent Application Publication
(10) Pub. No.: US 2006/0012674 A1
(43) Pub. Date: Jan. 19, 2006

(54) Image display system and method

(75) Inventor: Chung-Lun Kao, Macau (MO)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: CULTURE.COM TECHNOLOGY (MACAU) LTD., Macau (MO)

(21) Appl. No.: 10/892,079

(22) Filed: Jul. 14, 2004

(51) Int. Cl. H04N 13/04; H04N 15/00

(52) U.S. Cl. 348/51

(57) ABSTRACT

An image display system and a method thereof are provided. A focal point of a user's eyes is measured by a focus measuring module. A distance between the user's eyes and a display unit is measured by a distance measuring module. At least two parallax image data are retrieved from a storage medium by an image forming module, and a distance between the at least two parallax image data is adjusted by the image forming module based on the focal point of the user's eyes and the distance between the eyes and the display unit, so as to display the adjusted parallax image data on an imaging point of the display unit. By the above system and method, a stereo image can be provided on the display unit without adjusting the focal point of the user.

### FIELD OF THE INVENTION

The present invention relates to image display systems and methods, and more particularly, to a system and a method for displaying stereo images.

### BACKGROUND OF THE INVENTION

An image formed on the retina of a single human eye is only provided at a planar vision. Since the two human eyes are located on the same plane, the eyes can see the same object at the same time. Due to small mismatch in locations and vision angles of the two human eyes, images captured by the left eye and the right eye are slightly different in parallax from each other, and such images are integrated by the brain to produce a stereo image.

As described above, a real object can be identified and realized as a stereo image by the human eyes. However, the image of a real object captured and recorded in a tape or negative of an image capturing apparatus, e.g. a camera or video camera, would only be reproduced as a planar image. People may recognize what stereo object it represents according to their experience of scene depth and parallax in daily life. Although a photograph taken by the normal camera precisely records the size ratio and relative contrast and shading of object images and makes the images appear to be stereo, in fact the photograph does not provide stereo images if being seen at different directions or at broken pieces.

Since the planar images no longer satisfy the visual requirement of human beings, there have developed a plurality of methods for recording stereo images. Some of these well-known methods are described below.
1. Red/blue stereograph: a red/blue stereograph is provided based on the characteristic that lights in different colors cannot pass specific filters. Two pictures in different angles are made of red and blue lights respectively, wherein the red light is obtained by filtration through a red filter, and the blue light is obtained by filtration through a blue filter, such that the two different pictures are captured by the left eye and the right eye respectively and integrated via the brain to produce a stereo image.
2. Polaroid stereo movie: the mechanisms of the polaroid stereo movie and the red/blue stereograph are similar to each other, except that the polaroid stereo movie utilizes two polaroids having polarized directions orthogonal to each other to filter out undesired lights. The polaroid stereo movie is displayed by two synchronous projectors with lenses having polarized directions orthogonal to each other. Eyeglasses having polarized directions orthogonal to each other are worn on the eyes, making the left eye and the right eye receive different images to thereby provide a stereo effect. An advantage of the polaroid stereo movie is provision of full-color visions since the polaroids would not filter out different colors of lights.
3. Hologram: a hologram is different from a photograph but is obtained by a similar method. The hologram is also captured and recorded on a sensitive film, but the information recorded on the hologram sensitive film includes interference fringes unlike the normal photograph film that records reflection intensity values of different light waves on a single plane. The interference fringes are obtained by interference between light waves reflected from a real object and a reference light beam of a specific wavelength, instead of being produced by slits in an optical experiment. In other words, the reference light beam is required during image capturing. After development of the hologram, the light waves from the object may appear by irradiation of lights having the same wavelength as the reference light beam. Since the information recorded by the hologram is composed of two sets of light waves, the scene depth and parallax of the object are shown on the hologram. That is, when the stereo object images shown on the hologram can be seen in different directions or even when the hologram is broken into pieces. However, since the hologram requires irradiation of the specific light beam to produce the image and cannot be reproduced, it is thus not commonly and practically used.
4. Stereograph visible to naked eyes: the stereograph can be made by a simple method without the aid of any instrument, unlike the stereo images provided by the above methods that require the use of specific apparatuses and are not very convenient in operation. The simple method is to make two similar pictures based on a parallax difference and allow the two eyes to see the two pictures respectively, such that the two pictures can be integrated by the brain to produce a stereo image. Another type of the stereograph is named 3-D (three-dimensional) stereogram, is made of random dots and also called RDS (random dot stereogram). The method of producing RDS is simple and comprises taking one of two identical random dot grams and selecting a specific range on it; shifting the specific range horizontally, such that the two random dot grams are slightly different in parallax; and combining the two random dot grams through the eyes via the brain to form a stereo image.

Therefore, in the use of the foregoing conventional techniques to form a stereo image, it requires special eyeglasses or change of a focal point of the eye vision to observe the stereo image. As a result, the high cost of shoot and development of the stereo image, as well as the requirement of the special eyeglasses or change of the visual focal point, are a concern for users, thereby making stereo images not commonly used.

### SUMMARY OF THE INVENTION

In light of the prior-art drawbacks, a primary objective of the present invention is to provide an image display system and method, for allowing users to see stereo images without requiring specific filters or polaroid glasses.

In order to achieve the foregoing and other objectives, the present invention proposes an image display system, comprising: a focus measuring module for immediately measuring a focal point of a user's eyes; a distance measuring module for measuring a distance between the user's eyes and a display unit; a storage medium for storing parallax image data; and an image forming module for retrieving at least two of the parallax image data from the storage medium and adjusting a distance between the at least two parallax image data based on the focal point of the user's eyes and the distance between the eyes and the display unit so as to display the adjusted parallax image data on an imaging point of the display unit.

The present invention also proposes an image display method in the use of the above image display system, comprising the steps of: immediately measuring a focal point of a user's eyes via the focus measuring module; measuring a distance between the user's eyes and a display unit via the distance measuring module; retrieving at least two parallax image data from the storage medium and adjusting a distance between the at least two parallax image data based on the focal point of the user's eyes and the distance between the eyes and the display unit via the image forming module, so as to display the adjusted parallax image data on an imaging point of the display unit.

Compared with the conventional image display techniques, the image display system and method according to the present invention can provide a stereo image for users without concerning the high cost of shoot and development of stereo images and requiring specific filters or polaroid glasses.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing the basic architecture of an image display system according to the present invention; and

FIG. 2 is a flowchart showing the procedural steps of an image display method according to the present invention.

### DETAILED DESCRIPTION OF THE PREFERRED EMBODIMENT

In the following preferred embodiments provided for describing in detail an image display system and method proposed in the present invention, image data can be picture data, which may constitute static images or dynamic images composed of continuous static images. The picture data may comprise two similar pictures made by a parallax difference, or comprise RDS (random dot stereogram) made of random dots.

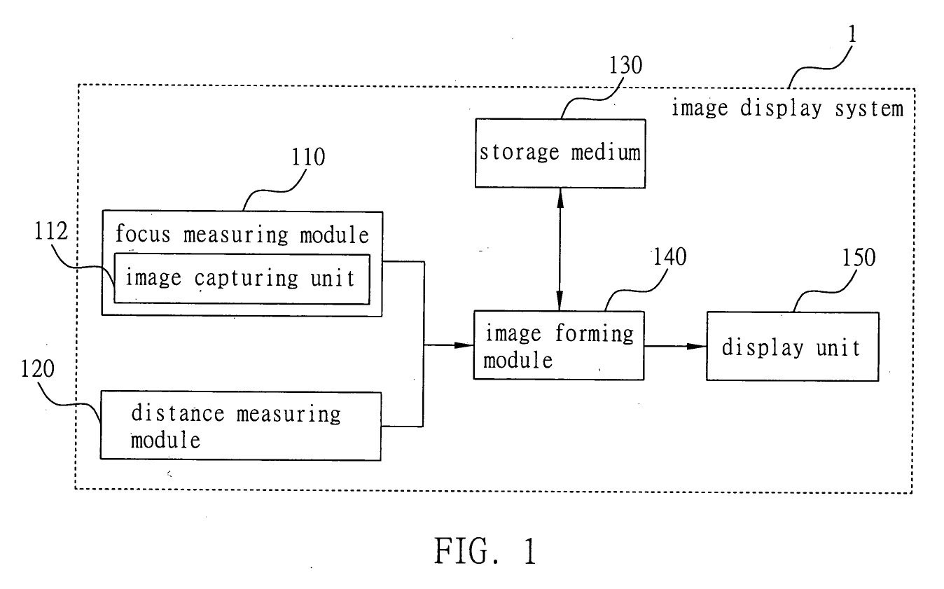

As shown in FIG. 1, the image display system 1 according to the present invention comprises: a focus measuring module 110; a distance measuring module 120; a storage medium 130; and an image forming module 140. Moreover, the image display system 1 is coupled with a display unit 150, e.g. a projector apparatus, for displaying the image data.

The focus measuring module 110 is used to immediately measure a focal point of a user's eyes. In this embodiment, the focus measuring module 110 comprises at least one image capturing unit 112, such as a CCD (charge-coupled device) lens, for capturing images of the user's eyes. After the images of the user's eyes are captured by the image capturing unit 12, the focus measuring module 110 calculates a focal length and a focal point of the user's eyes to obtain a distance between the focal point and the eyes.

The distance measuring module 120 is used to measure a distance between the user's eyes and the display unit 150. In this embodiment, the distance measuring module 120 may be an infrared distance sensor module and is located close to a position coplanar with an imaging point of the display unit 150. Preferably, the distance measuring module 120 can be embedded in the display unit 150 to precisely measure the distance between the user's eyes and the imaging point of the display unit 150.

The storage medium 130 is used to store parallax image data. As described above, in this embodiment, the image data can be picture data, which may constitute static images or dynamic images composed of continuous static images. The picture data may comprise two similar pictures made by a parallax difference, or comprise RDS made of random dots. In order to improve the efficiency of storing and processing the image data, it is preferable that the image data are stored in the form of digital files in the storage medium 130.

The image forming module 140 is used to retrieve at least two of the parallax image data from the storage medium 130 and adjust a distance between the at least two parallax image data based on the focal point of the user's eyes and the distance between the eyes and the display unit 150 so as to display the adjusted parallax image data on the imaging point of the display unit 150. As described above, in this embodiment, since the image data can be picture data, which may comprise two similar pictures made by a parallax difference or comprise RDS made of random dots, two picture data having a certain distance therebetween can be combined in a manner of uncrossed disparity (i.e. picture location is more far from the eyes than horopter) or crossed disparity (i.e. picture location is closer to the eyes than horopter) so as to form a stereo image.

It should be noted that, in the prior art that allows the naked eyes to observe two pictures different in parallax, the user needs to adjust a focal point of the eyes by himself or herself so as to combine these two pictures in an uncrossed disparity or crossed disparity manner to form a stereo image. On the other hand, in the present invention, the focus measuring module 110 can immediately measure a focal point of a user's eyes, and the distance measuring module 120 can measure a distance between the user's eyes and an imaging point of the display unit 150; finally, the image forming module 140 retrieves at least two parallax image data from the storage medium 130 and adjust a distance between the at least two parallax image data based on the focal point of the user's eyes and the distance between the eyes and the display unit 150 so as to display the adjusted parallax image data on the imaging point of the display unit 150, wherein the imaging point can be located in front of or behind the focal point of the user's eyes relative to the location of the eyes. Therefore, the user does not need to adjust the focal point of eyes to allow two pictures different in parallax to be combined to form a stereo image as in the prior art.

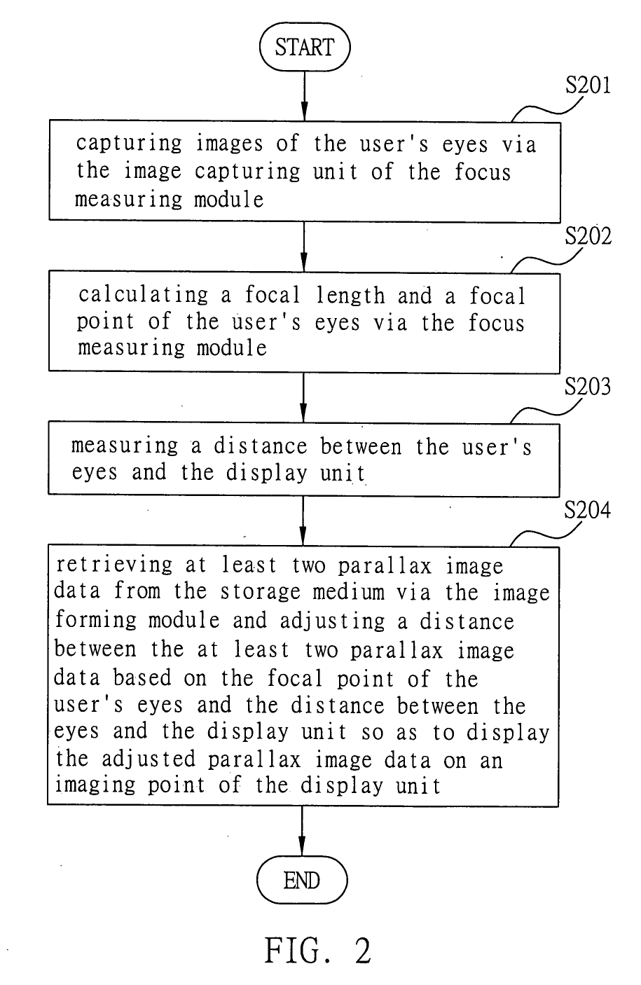

FIG. 2 shows the procedural steps of an image display method performed in the use of the image display system 1 according to the present invention.

In step S201, images of the user's eyes are captured by the image capturing unit 112 of the focus measuring module 110. Next, step S202 is performed.

In step S202, a focal length and a focal point of the user's eyes are calculated by the focus measuring module 110 to obtain a distance between the focal point and the eyes. Next, step S203 is performed.

In step S203, a distance between the user's eyes and the display unit 150 is measured by the distance measuring module 120. As described above, in this embodiment, the distance measuring module 120 can be an infrared distance sensor module and is located close to a position coplanar with the imaging point of the display unit 150, and it is preferable that the distance measuring module 120 may be embedded in the display unit 150 and is coplanar with the imaging point of the display unit 150 so as to precisely measure the distance between the user's eyes and the imaging point of the display unit 150. Next, the step S204 is performed.

In step S204, at least two parallax image data are retrieved from the image medium 130 by the image forming module 140, and a distance between the at least two parallax image data is adjusted based on the focal point of the user's eyes and the distance between the eyes and the display unit 150, such that the adjusted parallax image data can be displayed on the imaging point of the display unit 150. In this embodiment, the imaging point may be located in front of or behind the focal point of the user's eyes relative to the location of the eyes. Thus, the user needs not to adjust the focal point of eyes to allow two pictures different in parallax to be combined to form a stereo image as in the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. An image display system comprising:
a focus measuring module for immediately measuring a focal point of a user's eyes;
a distance measuring module for measuring a distance between the user's eyes and a display unit;
a storage medium for storing parallax image data; and
an image forming module for capturing at least two of the parallax image data from the storage medium and adjusting a distance between the at least two parallax image data based on the focal point of the user's eyes and the distance between the eyes and the display unit so as to display the adjusted parallax image data on an imaging point of the display unit.

2. The image display system of claim 1, wherein the focus measuring module comprises at least one image capturing unit for capturing images of the user's eyes.

3. The image display system of claim 2, wherein the image capturing unit is a CCD (charge-coupled device) lens.

4. The image display system of claim 1, wherein the distance measuring module is an infrared distance sensor module.

5. The image display system of claim 1, wherein the distance measuring module is located close to a position coplanar with the imaging point of the display unit.

6. The image display system of claim 1, wherein the distance measuring module is embedded in the display unit.

7. The image display system of claim 1, wherein the image data are stored in the form of digital files in the storage medium.

8. The image display system of claim 1, wherein the image data are picture data.

9. The image display system of claim 8, wherein the picture data constitute static images or dynamic images composed of continuous static images.

10. The image display system of claim 9, wherein the picture data comprise two similar pictures made by a parallax difference.

11. The image display system of claim 9, wherein the picture data comprise random dot stereogram made of random dots.

12. The image display system of claim 1, wherein the imaging point is located in front of the focal point of the user's eyes relative to the location of the eyes.

13. The image display system of claim 1, wherein the imaging point is located behind the focal point of the user's eyes relative to the location of the eyes.

14. An image display method comprising the steps of:
immediately measuring a focal point of a user's eyes via a focus measuring module;
measuring a distance between the user's eyes and a display unit via a distance measuring module; and
retrieving at least two parallax image data from a storage medium and adjusting a distance between the at least two parallax image data based on the focal point of the user's eyes and the distance between the eyes and the display unit via an image forming module so as to display the adjusted parallax image data on an imaging point of the display unit.

15. The image display method of claim 14, wherein the focus measuring module comprises at least one image capturing unit for capturing images of the user's eye.

16. The image display method of claim 15, wherein the image capturing unit is a CCD (charge-coupled device) lens.

17. The image display method of claim 14, wherein the distance measuring module is an infrared distance sensor module.

18. The image display method of claim 14, wherein the distance measuring module is located close to a position coplanar with the imaging point of the display unit.

19. The image display method of claim 14, wherein the distance measuring module is embedded in the display unit.

20. The image display method of claim 14, wherein the image data are stored in the form of digital files in the storage medium.

21. The image display method of claim 14, wherein the image data are picture data.

22. The image display method of claim 21, wherein the picture data constitute static images or dynamic images composed of static images.

23. The image display method of claim 22, wherein the picture data comprise two similar pictures made by a parallax difference.

24. The image display method of claim 22, wherein the picture data comprise random dot stereogram made of random dots.

25. The image display method of claim 22, wherein the imaging point is located in front of the focal point of the user's eyes relative to the location of the eyes.

26. The image display method of claim 14, wherein the imaging point is located behind the focal point of the user's eyes relative to the location of the eyes.
